(19) United States
(12) Patent Application Publication
(10) Pub. No.: US 2022/0188383 A1
(43) Pub. Date: Jun. 16, 2022

(54) HORIZON-BASED SMOOTHING OF FORECASTING MODEL

(71) Applicant: BUSINESS OBJECTS SOFTWARE LTD., Dublin (IE)

(72) Inventor: Jacques DOAN HUU, Montigny le Bretonneux (FR)

(21) Appl. No.: 17/120,400

(22) Filed: Dec. 14, 2020

(51) Int. Cl. G06F 17/18; G06N 20/00; G06N 3/04; G06N 3/08

(52) U.S. Cl. CPC G06F 17/18; G06N 3/08; G06N 3/0454; G06N 20/00

(57) ABSTRACT

Provided is a system and method which trains a model based on a horizon-wise cost function which accounts for error across a horizon rather than just a next point in time thereby improving the accuracy of the trained model in the long term. In one example, the method may include storing time-series data, executing a training iteration for a machine learning model based on one or more parameter values, determining error values between the predicted values output by the machine learning model and actual values of the time-series data for a plurality of intervals included in a horizon of the time-series data, generating a total error value for the horizon based on the determined error values for the intervals, and storing the generated total error value for the horizon. The method also enables a user to dynamically adjust a weight for each interval of the horizon.

### BACKGROUND

Time-series data contains sequential data points (e.g., data values) that are observed at successive time durations (e.g., hourly, daily, weekly, monthly, annually, etc.). For example, monthly rainfall, daily stock prices, annual profits, etc., are examples of time-series data. Forecasting is a machine learning process which can be used to observe historical values of time-series data and predict future values of the time-series data. There are numerous types of forecasting models. One of the most widely-used types is exponential smoothing which uses a weighted sum of past observations of the time-series to make predictions about future values of the data. In particular, exponential smoothing may use a decreasing weight for past observations.

The goal of an ETS (ExponenTial Smoothing) model is to find a simpler representation of the time-series data by mitigating local and abrupt changes in value over time. During learning based on historical data, ETS model parameters are optimized to fit actual data points by minimizing the error between actual values and forecasting values at (t+1) which is one-step ahead. This error is evaluated using a cost function (also referred to as an objective function, error function, etc.) The benefit of using a cost function based on a one-step ahead analysis is that the model typically fits well in the short term (e.g., the next data point). However, the forecasting model may significantly deteriorate for longer-term predictions. This is because the model does not fit well past the one-step ahead.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a process of training a machine learning model in accordance with an example embodiment.

FIG. 1B is a diagram illustrating a user interface displaying predicted values that are generated based on a traditional cost function.

FIG. 1C is a diagram illustrating a user interface 100C displaying predicted values 153 that are generated based on a horizon-wise cost function in accordance with an example embodiment.

FIG. 2 is a diagram illustrating an example of a horizon-wise cost function in accordance with example embodiments.

FIG. 3 is a diagram illustrating a user interface for modifying weights applied by the horizon-wise cost function in accordance with example embodiments.

FIG. 4 is a diagram illustrating a process of uniform sampling intervals of time with the horizon-wise cost function in accordance with an example embodiment.

FIG. 5 is a diagram illustrating a method of training a machine learning model with a horizon-wise cost function in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Exponential smoothing models are a well-known and often used class of timer-series forecasting models. Exponential smoothing models are applicable to a single set of values that are recorded over equal time increments. The models support data properties that are frequently found in business applications such as trends, seasonality, and time dependence. Model features may be trained based on available historical data. The trained model can then be used to forecast future values for the data.

ARIMA (Autoregressive Integrated Moving Average) and ETS are two of the more popular time-series forecasting techniques. An ARIMA model is a time-series model that can be used to train and forecast future data values in time. ETS is primarily a smoothing algorithm which is extended and used for time-series forecasting. ETS delivers acceptable accuracy/performance for short-term predictions (e.g., day ahead, etc.). However, ETS fails to deliver accurate performance on a consistent basis for longer term predictions (e.g., five days ahead, etc.).

A business analyst is typically building a time-series forecasting function for a period of time referred to as a horizon (h). In other words, the business analyst expects the predictive time-series forecasting function to be accurate until the horizon (h). However, in reality, the model is trained to minimize error with respect to only a next interval of time (t+1). Therefore, when (h) is greater than (1), the model struggles to be accurate after (t+1). That is, the model struggles to be accurate until (t+h). For example, the horizon (h) may include seven intervals (t+7). In this case, the model may work well for the first interval (t+1) and be very inaccurate for the next six intervals (t+2, t+7).

The example embodiments overcome the drawbacks of the ETS technique by integrating a cost function that determines error for a horizon of data, rather than just a single step ahead. In particular, the horizon-wise cost function considers the error over a plurality of future data points (e.g., t+h) rather than just a next data point (e.g., t+1). As a result, fluctuations in the data are smoothed out over time resulting in a more accurate prediction in the long term. Furthermore, the example embodiments may also integrate a uniform sampling process into the error detection to mitigate the extra processing that is done. The result is that the time-series forecasting model is more accurate (i.e., more accurate predictions in comparison to the actual time-series output) in the long term.

A cost function (also referred to herein as an error function, a loss function, an objective function, etc.) is used during training of a machine learning algorithm to quantify the error between predicted values and expected values. The output of the cost function is a real number. The goal of training a machine learning algorithm is to find model parameters for which the cost function returns as small a number as possible. Some of the metrics that may be used by the cost function include mean squared error (MSE), mean absolute error (MAE), and the like. However, a typical cost function is used to fit the data to a next step in time (i.e., t+1). When the trained model is used to make predictions for subsequent periods of time (e.g., t+5), the model's performance may suffer because it has been overfit to the next step in time.

In the example embodiments, a new cost function is introduced and is referred to as a horizon-wise cost function. The horizon-wise cost function considers the error over a plurality of intervals of time up to a horizon (h). As a non-limiting example, the horizon may include seven intervals of time when forecasting data for an entire week, etc. By analyzing error over a longer period of time (i.e., a horizon), the horizon-wise cost function helps create a time-series forecasting model that better fits over a horizon of time, rather than a next interval in time.

The objective of smoothing is to find a simpler representation of time-series data by mitigating sudden and local variations in the data over time. Meanwhile, the objective of forecasting is to discover an underlying consistent structure (e.g., a pattern) from time-series data which is likely to be repeated. Forecasting techniques such as ETS reside in between these two objectives. The ETS model is based on a state dependency hypothesis which defines a structure. ETS is at some extent a sophisticated moving average enabling to smooth data. ETS also has two distinct formulations (learning and forecasting). In this case, the learning procedure is based on smoothing or the moving average paradigm, and the forecasting procedure is used to predict a future value at horizon (h) based on a function f(t, h).

As noted, the problem with ETS is that it has imbalanced accuracy. The learning procedure is ignorant of the forecasting accuracy beyond a next interval (t+1). Therefore, for predictions of intervals after (t+1), the performance deteriorates. This is because the ETS parameters are optimized to minimize the error (using the traditional cost function) between the actual values and the forecasted values at the next interval (t+1). The result is that ETS overfits the model in the short term but fails to account for changes in the long term.

The horizon-wise cost function described herein can reconciliate the learning and the forecasting procedures by sharing a common goal. The learning optimizes predictions for the long term (h) which may include a plurality of intervals of time and the forecasting is optimized to be accurate until h. The horizon-wise cost function accounts for error over a horizon of time which includes multiple intervals, rather than just the one-step ahead as is done traditionally. Thus, the trained model fits better across a horizon of time than a model trained with a traditional cost function.

The example embodiments also enable a user to dynamically adjust weights that are applied at each interval of a horizon. For example, if the user wants the model to be more accurate on a specific day of the week (e.g., Wednesday), the user may apply a greater weight to the interval (t+3) and less weight to other intervals in the horizon which may include a total of 7 intervals (7 days=t+7). Furthermore, to reduce CPU time, the error determination may use uniform sampling where only some, but not all, of the intervals of time are used for error detection. The uniform sampling may be shifted each horizon (training iteration) to prevent overfitting on a particular interval or intervals of time.

ETS uses different smoothing parameters (e.g., alpha, beta, gamma, trend, dampen, phi, seasonality, etc.). At each iteration of the training, the model may be executed on training data using values for the different smoothing parameters. Here, an error between the predicted values for the time-series data across a horizon, and the actual values of the time-series data across the horizon may be determined using the horizon-wise cost function. In response, the parameters may be modified to better fit the data based on an error determination made by the horizon-wise cost function. This process may be repeated until the model best fits the horizon.

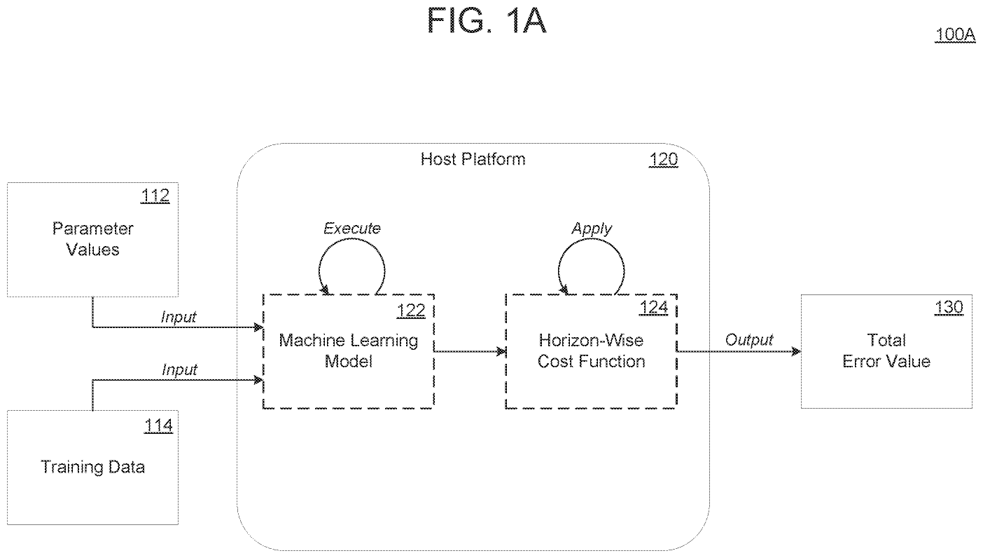

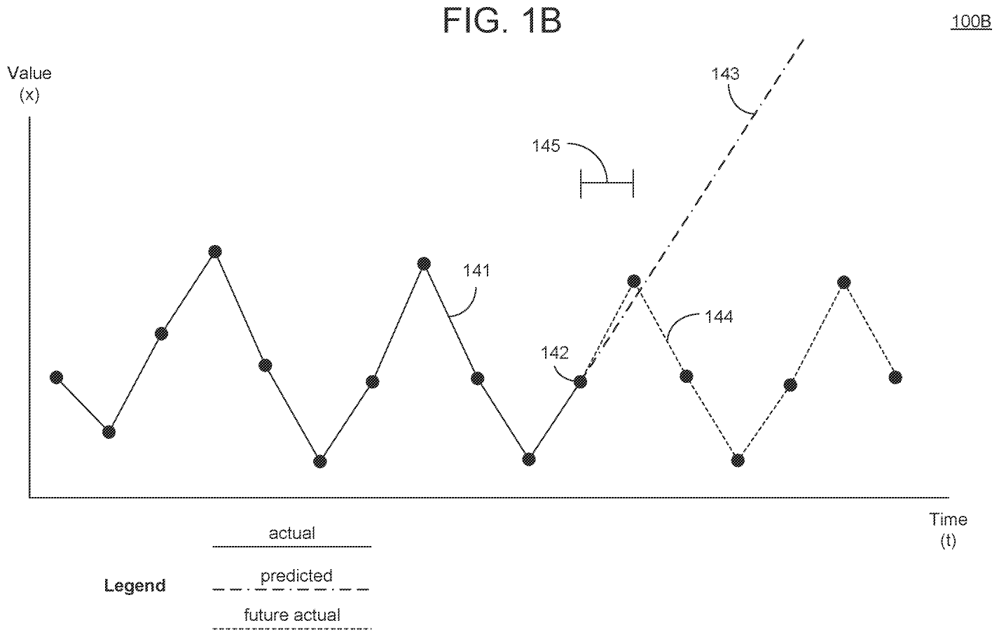

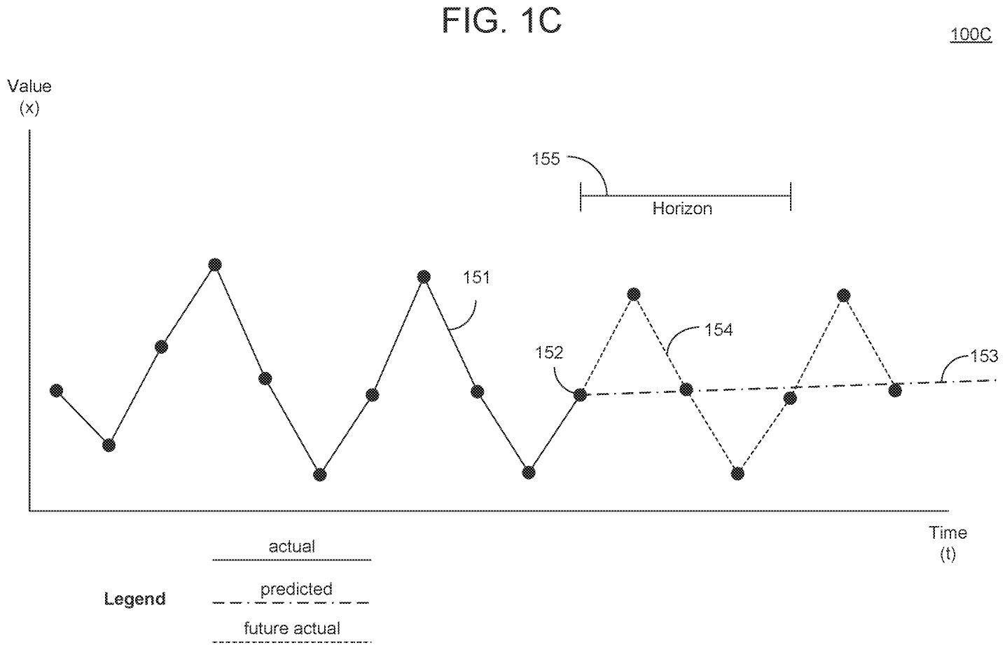

FIG. 1A illustrates a process 100A of training a machine learning model in accordance with an example embodiment. Referring to FIG. 1A, a host platform 120, for example, a cloud platform, a web server, a user device, a database, or the like, may execute a machine learning model 122 during a training process. In this example, the machine learning model 122 may be a time-series forecasting model such as ETS, or the like. Parameter values 112 (e.g., smoothing parameters) may be input to the machine learning model 122. For example, the parameter values 112 may be randomly chosen by the host platform 120, input by a user via a user interface, etc. Likewise, training data 114 may be provided to the machine learning model 122. The training data 114 may include historical values of time-series data.

The host platform 120 may execute a training iteration of the machine learning model 122 on the input parameter values 112 and the training data 114. Here, the forecasts may include forecasts for multiple intervals of time equal to a horizon value (h). As an example, the horizon may include 3 intervals, 4 intervals, 5 intervals, 6 intervals, 7 intervals, and the like. Next, the host platform 120 may apply a horizon-wise cost function 124 to the predicted values output by the machine learning model 122. Here, the horizon-wise cost function 124 may determine a total error value 130 for the training iteration based on individual error values determined from a plurality of intervals of the horizon. Based on the output total error value 130, the user or the host platform 120 may adjust the parameters 112 and retrain the machine learning model 122 based on the adjusted parameters 112. Again, the horizon-wise cost function 124 may be used to determine the total error value 130 for the next training iteration. This process may be repeated as many times as desired until the trained machine learning model 122 has reached a desired level of accuracy.

FIG. 1B illustrates a user interface 100B displaying predicted values 143 that are generated based on a traditional cost function. Referring to FIG. 1B, the solid line 141 represents actual values of time-series data. At a point 142, a forecasting model forecasts values 143 of the time series data (represented by dashed line). Meanwhile, actual future values 144 of the time-series data are represented by the smaller dashed line. As can be seen in this example, the forecasted values 143 are significantly off after t+1 which is represented by item 145. In this case, the cost function only considers the error on a one-step ahead basis. Therefore, the predicted values 143 are accurate for a next data point, but they are inaccurate for the other data points including t+2 and beyond.

FIG. 1C illustrates a user interface 100C displaying predicted values 153 that are generated based on a horizon-wise cost function in accordance with an example embodiment. In this example, the actual data values 151 are represented by the solid line. At a point 152, the time-series forecasting model predicts future values 153 of the time-series data. However, rather than using a traditional cost function that is based on the error over a next step, the system uses a horizon-wise cost function that considers the error over a horizon 155. As a result, the predicted future values 153 are much more accurate to actual future values 154 of the time-series data than is the case in FIG. 1B. That is, because the horizon-wise cost function used to generate the predicted values 153 is based on a horizon-wise error including multiple time intervals into the future, the predicted values 153 are more accurate than the predicted values 143 shown in FIG. 1B, which is based on a one-step ahead error determination. Furthermore, each time the horizon-wise cost function is applied (e.g., in subsequent iterations), the model will continue to be fitted to future data in a better manner than if only based on one-step ahead error determination.

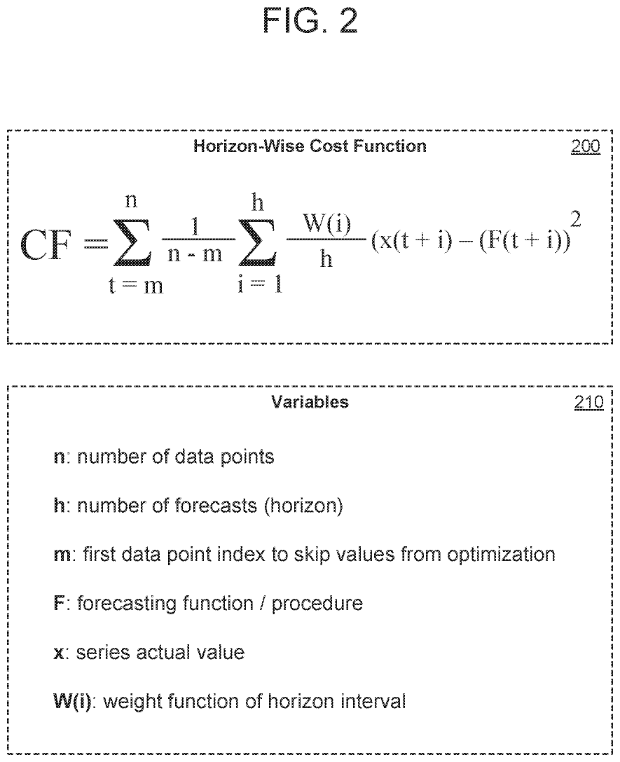

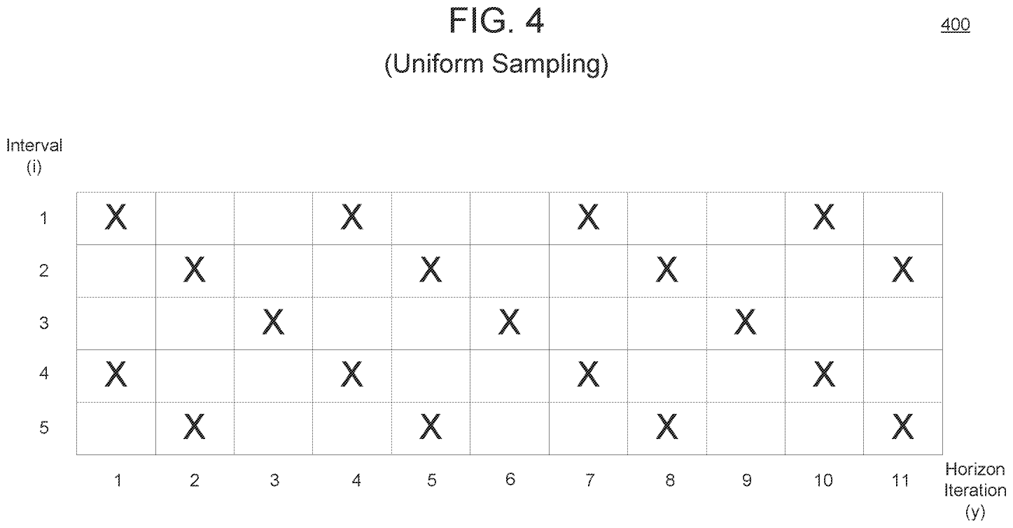

FIG. 2 illustrates an example of a horizon-wise cost function 200 in accordance with example embodiments including variables 210. In this example, the horizon-wise cost function 200 is configured to impose better forecasting performance for a machine learning model (F) over a series or sequence of time intervals (i) included in a horizon (h). For example, the horizon (h) may include two intervals, three intervals, four intervals, six intervals, ten intervals, etc. In some embodiments, the horizon-wise cost function 200 may determine the error (CF) for each time interval i from i=1 to i=h. As a non-limiting example, if h=12, then the horizon-wise cost function 200 may determine an error value for each of the twelve intervals (and 12 corresponding forecasts) from i=1 to i=12. As another example, and as further described below with respect to FIG. 4, the system may uniformly sample intervals (e.g., every third, every fifth, every 10^{th}, etc.) so that the processing time can be reduced. Also, in the uniform sampling example, which interval is sampled may be shifted at each training iteration to ensure that the model is not overfitted to a specific interval.

In this example, the variable (n) refers to the data points that are being predicted, (t) refers to time, (i) refers to the interval of time being predicted, and (x) refers to the actual data point at the point in time. In this example, (F) refers to the predicted value generated by a forecasting function/procedure of a time-series forecasting model (e.g., machine learning model). Meanwhile, W(i) refers to the weight that may be applied by the horizon-wise cost function to a given interval (i). Also, the variable (h) refers to the number of intervals (i) that are included in a horizon. To determine the error, the predicted value for a given interval (i) is subtracted from the actual value (x) for the given interval (i). The difference is then squared and multiplied by a weight for the given interval (i) divided by the number of intervals in the horizon (h). This process may be repeated for a plurality of intervals within the horizon (h). The resulting error values may be aggregated together to determine a total error value for a given data point (n).

As a non-limiting example, if the horizon (h) is one week of time and the interval (i) is one day, the number of intervals (i) in the horizon (h) is seven (7). Therefore, (t+i) refers to the interval (day) being used for error determination. If the interval is t+3 then the interval refers to the third time interval (e.g., Wednesday). The horizon-wise cost function may sum the error of the predicted value (generated by the model) versus the actual value included in the data, to determine an error value for that interval. The error values for the intervals of all days may be summed together to generate a total error value for the training iteration.

However, in some embodiments, the training may skip an initial amount of data points represented by index (m) which may be used for optimizing the cost function. The index (m) may initially be set to zero, but may be modified by a user. Also, the training may selectively sample only a partial amount of intervals (i) during a given horizon (h).

The horizon-wise cost function 200 generates a horizon-wise total error for the training of the model. Each forecasted data point F is compared to the actual data point X for a particular time interval (t+i), until h intervals of error have been determined. The horizon-wise cost function 200 creates a sum of the errors for the different intervals of the horizon that are forecasted during the training. The idea is to reduce the cost function over time. Therefore, the parameters used for the forecasting function may be changed (e.g., alpha, beta, gamma, phi, seasonal, etc.) in a next iteration of the training.

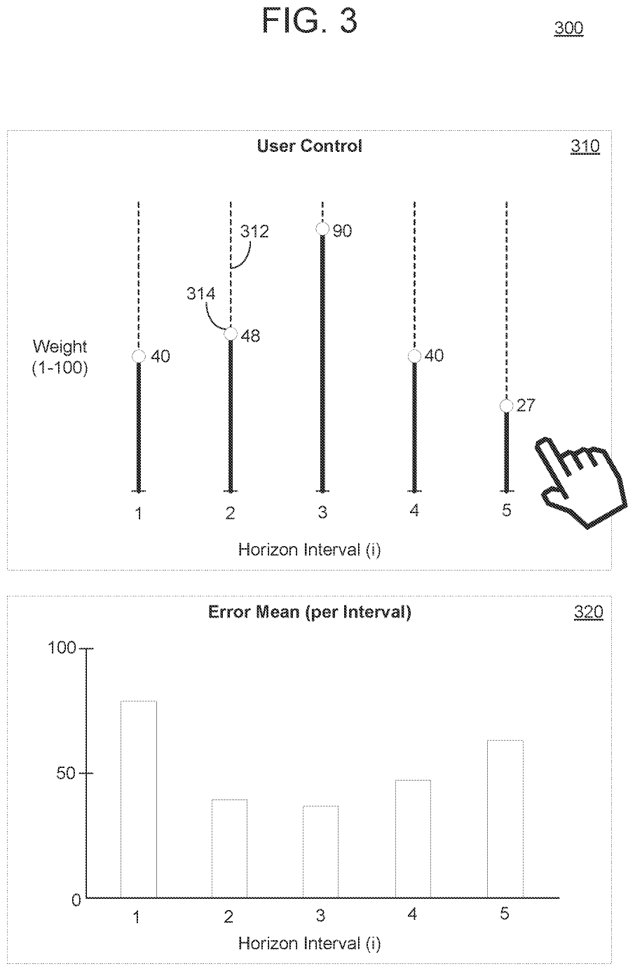

FIG. 3 illustrates a user interface 300 for modifying weights applied by the horizon-wise cost function in accordance with example embodiments. Referring to FIG. 3, a use may trigger or otherwise launch a user control window 310 while training a machine learning model (e.g., a time-series forecasting model) via a host platform. In this example, the model is being trained based on a horizon of time that includes five (5) intervals. As an example, the five intervals may correspond to the five “business” days of a week. Here, the user may be interested in developing a model that is particularly accurate on Wednesdays. Therefore, the user can apply weights to one or more of the intervals.

In this example, the user control window 310 includes an individual slider function for each interval among the five intervals. Accordingly, the user can control a slider button 314 to move along an axis 312 of the slider function to increase or decrease a weight that is associated with that interval. In this case, the user has increased the weight associated with interval three (3) which corresponds to Wednesday, and decreased the weight of the other intervals. When the model is executed (i.e., during a training iteration), the results of the training may be output as an error mean value for each of the intervals of the horizon as shown in the error mean window 320. If the distribution of the error mean values doesn't fit an expectation of a user (e.g., an analyst, etc.), the user can assign more weight on particular intervals with error mean lower than expected and then retrain the predictive model. This tuning process can be repeated until reaching a satisfactory error relative distribution.

FIG. 4 illustrates a process 400 of uniform sampling intervals of time with the horizon-wise cost function in accordance with an example embodiment. As will be appreciated, by performing an error determination for a plurality of intervals within a horizon(h), the computations necessary also increase by a factor of the number of intervals. For example, if the horizon has 5 intervals of time, then the computation for the horizon-wise cost function would by five times greater than a traditional cost function which does not consider a horizon of intervals. To reduce the number of computations/processing performed by the host platform, error determination may only be performed on a partial amount of the intervals within a horizon.

Referring to FIG. 4, each horizon includes five intervals of time. Rather than compute the error for all five intervals of time, in each horizon, the horizon-wise cost function may uniformly sample only some of the intervals. In this example, the horizon-wise cost function uniformly samples every third interval. To prevent the uniform sampling from unevenly training the predictive model for a given interval, the uniform sampling may be shifted by a predetermined value. For example, in a second training iteration (h=2), the uniform sampling may be shifted by one so that the sampling starts at the second interval and also samples the fifth interval. This process may be repeated at each horizon shifting the intervals by one and performing the uniform sampling.

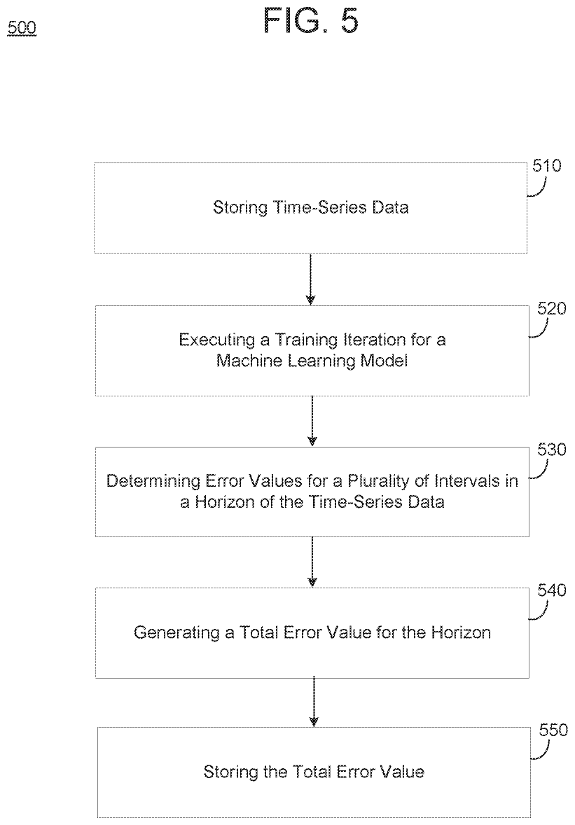

FIG. 5 illustrates a method 500 of training a machine learning model with a horizon-wise cost function in accordance with an example embodiment. For example, the method 500 may be executed by a database node, a cloud platform, a server, a computing system (user device), a combination of devices/nodes, or the like. Referring to FIG. 5, in 510, the method may include storing time-series data such as historical time-series that has been observed. In some embodiments, the method may also include receiving initial parameters or subsequent parameters for a machine-learning model such as a time-series forecasting model. The parameters are the values associated with the different variables in the algorithm (e.g., function, procedure, etc.) executed by the time-series forecasting model. Examples of time-series forecasting parameters include number of lag observations, degree of differencing, and size of the moving average window, but embodiments are not limited thereto.

In 520, the method may include executing a training iteration for a machine learning model based on one or more parameter values, wherein the executing comprises inputting training data into the machine learning model and outputting predicted values. The training iteration may be repeated for a plurality of time intervals within a horizon. In 530, the method may include determining error values between the predicted values output by the machine learning model and actual values of the time-series data for a plurality of intervals included in a horizon of the time-series data. For example, the error may be determined using a horizon-wise cost function. Likewise, in 540, the method may include generating a total error value for the horizon based on the determined error values for the plurality of intervals. The total error may be determined by the horizon-wise error function which aggregates the interval errors across a horizon into a total error value. In 550, the method may include storing the generated total error value for the horizon.

In some embodiments, the generating the total error value may include applying different weights to different determined error values of the plurality of intervals when generating the total error value for the horizon. In some embodiments, the determining may include determining error values for only a partial amount of intervals in the horizon rather than all intervals in the horizon. For example, uniform sampling of time intervals may be performed within a horizon. As the training iterations increment, the time intervals that are sampled may also be shifted to prevent overfitting on a particular interval of time within a horizon that includes multiple intervals of time.

In some embodiments, the method may further include executing a next training iteration for the machine learning model based on one or more new parameter values, and determining a total error value for the next iteration based on error values determined between predicted values output by the machine learning model and actual values of the time-series data for a different horizon. In some embodiments, the determining may include determining the error values of the plurality of intervals based on a horizon error function (e.g., horizon-wise cost function). In some embodiments, the determining may include determining a difference between output values of the machine learning model and the actual values of the time-series data for the plurality of intervals of the horizon, during the training iteration. In some embodiments, the method may further include dynamically modifying a weight that is applied to an interval from among the plurality of intervals in the horizon based on a received input.

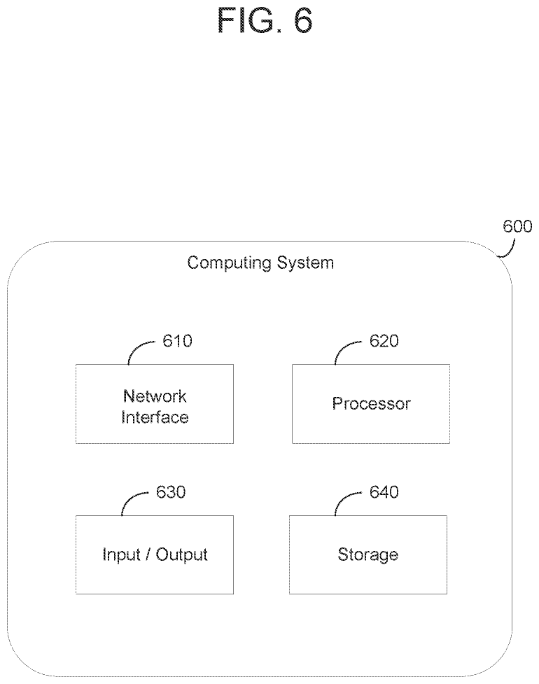

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the method shown in FIG. 5. According to various embodiments, the storage 640 may include a data store having a plurality of tables, records, partitions and sub-partitions. The storage 640 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a memory configured to store time-series data; and
a processor configured to
execute a training iteration for a machine learning model based on one or more parameter values, wherein the executing comprises inputting training data into the machine learning model and outputting predicted values,
determine error values between the predicted values output by the machine learning model and actual values of the time-series data for a plurality of intervals included in a horizon,
generate a total error value for the horizon based on the determined error values for the plurality of intervals, and
store the generated total error value for the horizon in the memory.

2. The computing system of claim 1, wherein the processor is configured to apply different weights to different determined error values of the plurality of intervals when generating the total error value for the horizon.

3. The computing system of claim 1, wherein the processor is configured to determine error values for only a partial amount of intervals in the horizon rather than all intervals in the horizon.

4. The computing system of claim 1, wherein the processor is further configured to execute a next training iteration for the machine learning model based on one or more new parameter values, and determine a total error value for the next iteration based on error values determined between predicted values output by the machine learning model and actual values of the time-series data for a different horizon.

5. The computing system of claim 1, wherein the processor is configured to determine the error values of the plurality of intervals based on a horizon error function.

6. The computing system of claim 1, wherein the processor is configured to determine a difference between output values of the machine learning model and the actual values of the time-series data for the plurality of intervals of the horizon, during the training iteration.

7. The computing system of claim 1, wherein the processor is configured to dynamically modify a weight that is applied to an interval from among the plurality of intervals in the horizon based on a received input.

8. A method comprising:
storing time-series data;
executing a training iteration for a machine learning model based on one or more parameter values, wherein the executing comprises inputting training data into the machine learning model and outputting predicted values;
determining error values between the predicted values output by the machine learning model and actual values of the time-series data for a plurality of intervals included in a horizon of the time-series data;
generating a total error value for the horizon based on the determined error values for the plurality of intervals; and
storing the generated total error value for the horizon.

9. The method of claim 8, wherein the generating comprises applying different weights to different determined error values of the plurality of intervals when generating the total error value for the horizon.

10. The method of claim 8, wherein the determining comprises determining error values for only a partial amount of intervals in the horizon rather than all intervals in the horizon.

11. The method of claim 8, wherein the method further comprises executing a next training iteration for the machine learning model based on one or more new parameter values, and determining a total error value for the next iteration based on error values determined between predicted values output by the machine learning model and actual values of the time-series data for a different horizon.

12. The method of claim 8, wherein the determining comprises determining the error values of the plurality of intervals based on a horizon error function.

13. The method of claim 8, wherein the determining comprises determining a difference between output values of the machine learning model and the actual values of the time-series data for the plurality of intervals of the horizon, during the training iteration.

14. The method of claim 8, wherein the method further comprises dynamically modifying a weight that is applied to an interval from among the plurality of intervals in the horizon based on a received input.

15. A non-transitory computer-readable medium comprising instructions which when executed by a processor cause a computer to perform a method comprising:
storing time-series data;
executing a training iteration for a machine learning model based on one or more parameter values, wherein the executing comprises inputting training data into the machine learning model and outputting predicted values;
determining error values between the predicted values output by the machine learning model and actual values of the time-series data for a plurality of intervals included in a horizon of the time-series data;
generating a total error value for the horizon based on the determined error values for the plurality of intervals; and
storing the generated total error value for the horizon.

16. The non-transitory computer-readable medium of claim 15, wherein the generating comprises applying different weights to different determined error values of the plurality of intervals when generating the total error value for the horizon.

17. The non-transitory computer-readable medium of claim 15, wherein the determining comprises determining error values for only a partial amount of intervals in the horizon rather than all intervals in the horizon.

18. The non-transitory computer-readable medium of claim 15, wherein the method further comprises executing a next training iteration for the machine learning model based on one or more new parameter values, and determining a total error value for the next iteration based on error values determined between predicted values output by the machine learning model and actual values of the time-series data for a different horizon.

19. The non-transitory computer-readable medium of claim 15, wherein the determining comprises determining the error values of the plurality of intervals based on a horizon error function.

20. The non-transitory computer-readable medium of claim 15, wherein the determining comprises determining a difference between output values of the machine learning model and the actual values of the time-series data for the plurality of intervals of the horizon, during the training iteration.
